(19) United States
(12) Patent Application Publication
(10) Pub. No.: US 2016/0347021 A1
(43) Pub. Date: Dec. 1, 2016

(54) EQUIPMENT AND METHOD FOR THE PRODUCTION OF CARDBOARD TUBES

(71) Applicant: FUTURA S.P.A., Capannori (LU), Fraz. Guamo (IT)

(72) Inventor: Fabio PERINI, Viareggio (LU) (IT)

(73) Assignee: FUTURA S.P.A., Capannori (LU), Fraz. Guamo (IT)

(21) Appl. No.: 15/114,629

(22) PCT Filed: Jan. 9, 2015
(86) PCT No.: PCT/IT2015/000001

§ 371 Date: Jul. 27, 2016

(30) Foreign Application Priority Data
Jan. 29, 2014 (IT) FI2014A000015

(51) Int. Cl. B31C 3/00; B31C 11/04

(52) U.S. Cl. CPC B31C 3/00; B31C 11/04

(57) ABSTRACT

Equipment for the production of cardboard tubes, comprising a tube-forming machine (1) provided with means for forming cardboard tubes with strips of cardboard (3) helically wound on a forming spindle (10), comprising a feeding unit (2) for feeding said cardboard strips, and comprising guide means (4) for guiding the cardboard strips (3) along a predetermined path (30, 31, 32) between the feeding unit (2) and the tube-forming machine (1), wherein in a final section (32) of said path the strips of cardboard (3) enter into the tube-forming machine (1). The guide means (4) are arranged and acting, along the said path, such that in said final section (32) of said path the cardboard strips (3) enter from the above or from the bottom into the tube-forming machine (1), so that said final section (32) is a descending or an ascending section of said path.

The present invention relates to an equipment and a method for the production of cardboard tubes, in particular for the paper converting industry. It is known that in paper converting plants a “tube-forming” machine produces rigid cardboard tubes (also called “core”) on which the paper is wound to form a roll or “log” which is subsequently divided into more elements having a predefined length in order to obtain rolls of toilet paper, rolls of kitchen paper etc.

Each tube is obtained from strips of cardboard, fed by corresponding reels, which are helically wound on a metal spindle with horizontal axis and glued one on the other so as to form a self-supporting tubular structure. Generally, use is made of two or three strips of cardboard, depending on the desired thickness of the cores to be produced. It is also possible to produce tubular cores from a single cardboard strip and have customized cardboard feeding units. The cardboard strips are partially superimposed on each other and, by means of an eight-shaped belt they are wound on two guide rollers, are rolled around the mandrel and pushed forward, thus obtaining the tubular cardboard core that advances along the same spindle. Said belt wraps also around the spindle so as to engage the strips of cardboard.

Through a suitable cutting unit, the tubular cardboard core is cut to a predetermined length which substantially corresponds to the length of the logs to be produced by other machines that are normally called “rewinders”.

The cardboard strips come from feeding units comprising reels from which the same cardboard strips are unwound, following a direct path between each feeding unit and the spindle of the tube-forming machine. Since the spindle is normally positioned at about one meter above the basement of the tube-forming machine, the space between the cardboard feeding units and the tube-forming machine is occupied by the cardboard strips. Therefore, it is not possible to position the cardboard feeding units and the tube-forming machine opposite to one another, otherwise the operators are not allowed to move freely between them, and the positioning of the cardboard feeding units and the tube-forming machines requires a wider space.

The main purpose of the present invention is to eliminate, or at least greatly reduce, the aforementioned drawbacks.

This result is achieved, according to the present invention, by adopting the idea of providing an apparatus and implementing a method having the characteristics indicated in the independent claims. Other features of the present invention are object of the dependent claims.

Thanks to the present invention, it is possible to have the cardboard feeding unit and the tube-forming machine facing one another without, however, preventing an operator to move freely between them and, therefore, obtaining the advantage of placing the cardboard feeding unit and the tube-forming machine according to a most efficient arrangement. In addition, the implementation of the present invention requires a very low expenditure in relation to the benefits.

These and other advantages and features of the present invention will be more understood by anyone skilled in the art from the following description and with the aid of the attached drawings, given as a practical exemplification of the invention, but not to be considered in a limiting sense, in which:

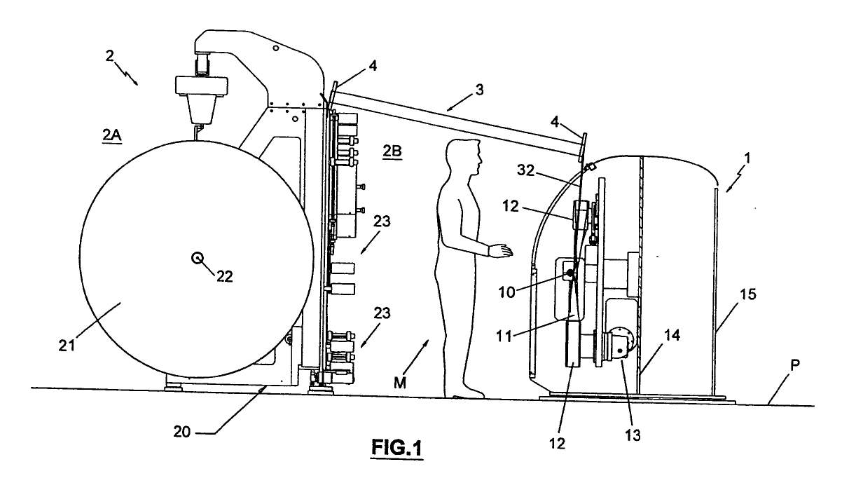

FIG. 1 is a schematic side view of an equipment according to the present invention;

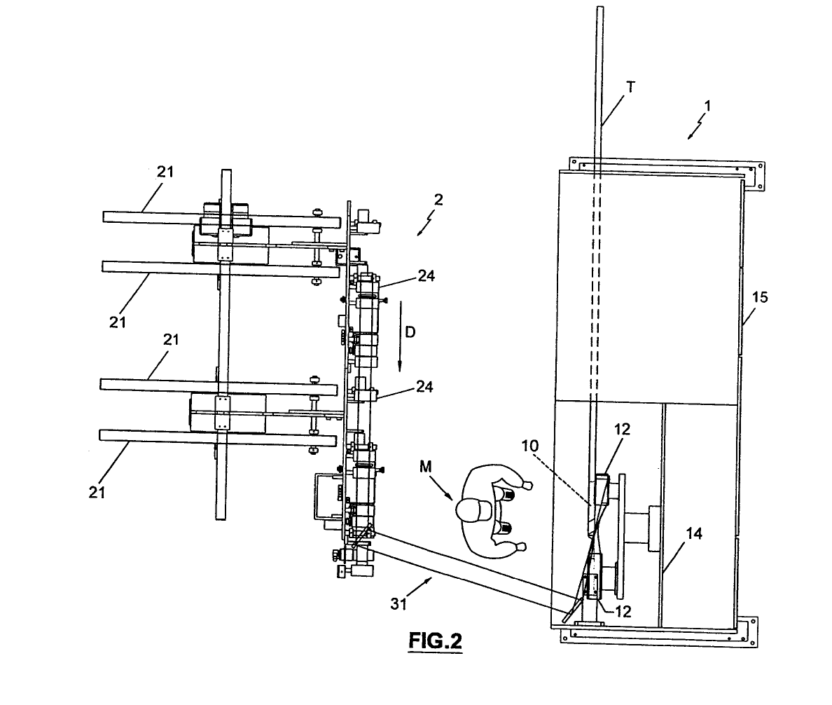

FIG. 2 is a schematic view from the above of the equipment shown in FIG. 1;

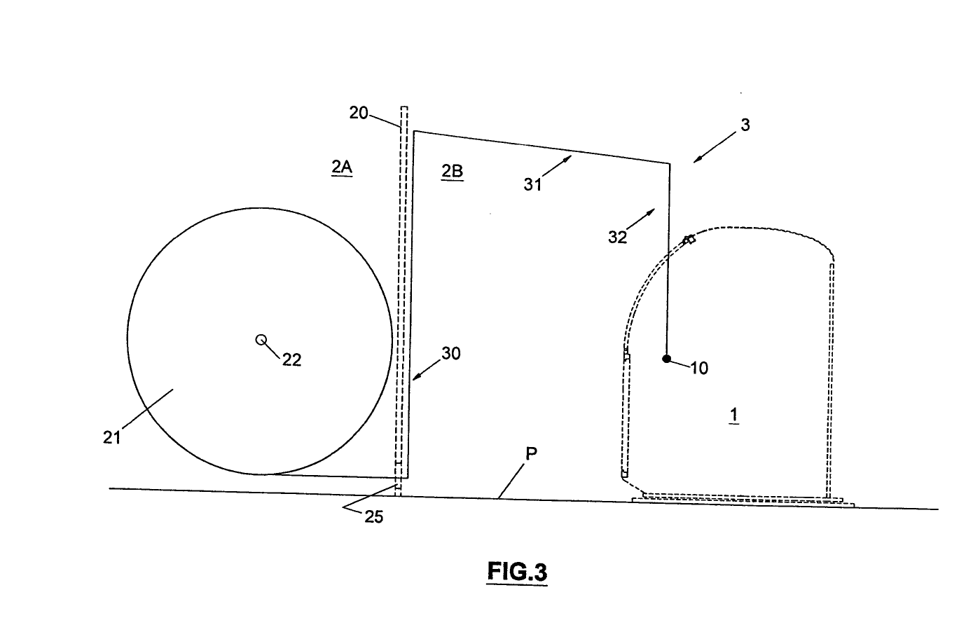

FIG. 3 is a scheme that shows the path followed by the cardboard strips;

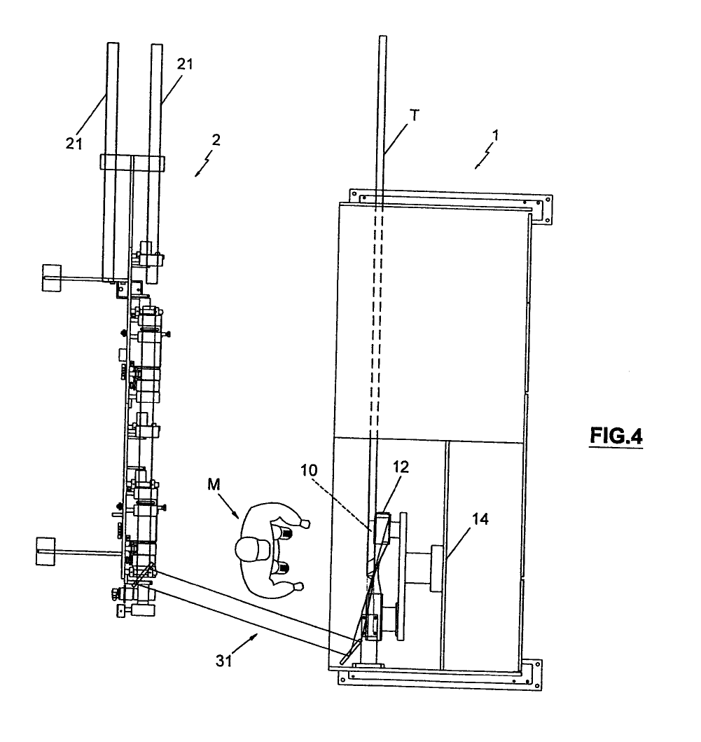

FIG. 4 shows another arrangement of the reels by which the cardboard strips are supplied.

Reduced to its basic structure and with reference to the attached drawings, the equipment according to the present invention comprises a tube-forming machine (1) and a feeding unit (2) that supplies the tube-forming machine with the cardboard required for forming the cardboard tubes. The tube-forming machine (1) and the feeding unit (2) are known per se. In particular, with reference to the example shown in the attached drawings, the tube (1) is of the type comprising a spindle (10) served by a belt (11) wound on two pulleys (12) so as to form a “8”-shaped figure. One of said pulleys is connected to a gear motor (13), while the other pulley is free to rotate about its own axis. The unit constituted by the gear motor (13), the pulleys (12) and the spindle (10) is supported by a structure (14) protected by a casing (15). The belt (11) drags the glued cardboard strips (3) coming from the supply unit (2) and wounds them on the spindle (10), making them simultaneously move parallel to the longitudinal axis of the spindle. A tube-forming machine of this type is described, for example, in WO 95/10400 and WO 95/10399.

The feeding unit (2) is of the type comprising a support structure (20), which, on one side (2A), supports one or more reels (21) with horizontal axis (22) from which the cardboard strips (3) are unwound and, on the other side (2B)supports a series of rollers for guiding and tensioning the cardboard strips (3) and a plurality of tanks containing liquid glue that is applied on a lower side of the same cardboard strips (3) dragged by the belt (1) as disclosed above. The structure (20) has a series of slits (25) through which the cardboard strips (3) of the reels (21) can pass from the side (2A) to the side (2B) of the structure (20). In practice, while advancing along a direction (D) parallel to the side (2B) of the structure (20), the strips of cardboard (3) receive a predetermined quantity of liquid glue on their lower side. A feeding unit so structured and functioning is described in U.S. Pat. No. 7,407,470.

Advantageously, according to the present invention, the tube-forming machine (1) and the feed unit (2) are provided with guide means adapted to force the cardboard strips (3 to enter the tube-forming machine (1) from the above. For example, the said guide means are constituted by rollers (4) respectively placed on the second side (2B) of the structure (20) and on top of the casing (15). In this way, the tube-forming machine (1) and the feed unit (2) can be placed one opposite the other (as shown in FIG. 2) and the space between the tube-forming machine (1) and the feed unit (2) is freely accessible, so there is a more rational arrangement of the machines and an operator (M) can move freely between them to operate both the machines without being forced to constantly move around them.

In FIG. 3, a strip of cardboard (3) follows a path that has a first section (30) between a slot (25) of the structure (20) and a point at a predetermined height relative to the floor (P) on which rest the feed unit (2) and the tube-forming machine (1), a second section (31) overhanging the space between the feed unit (2) and the tube-forming machine (1), and a third section (32) which, from above, enters the tube-forming machine (1) from an upper opening of the casing (15) and reaches the spindle (10). For example, the said second section (31) is at a height greater than 1.70 m above the floor.

In FIG. 2 the cardboard tube that comes out of the tube-forming machine (1) is denoted by the reference “T”.

FIG. 2 shows, in particular, the tube-forming machine (1) and the feed unit (2) with the spindle (10) oriented parallel to the axis (22) that supports the reels (21), so that the tube-forming machine (1) and the feed unit (2) are positioned perfectly opposite to one another.

In accordance with the present invention, a method for the production of cardboard tubes, comprises the use of a tube-forming machine (1) provided with means for forming cardboard tubes with strips of cardboard (3) wrapped helically about a forming spindle (10), comprises the use of a unit (2) for feeding said cardboard strips, and comprises the use of guide means (4) for guiding the cardboard strips (3) along a predetermined path (30 , 31, 32) between the feed unit (2) and the tube-forming machine (1), wherein in a final leg (32) of said path the strips of cardboard (3) enter the tube-forming machine (1), and in said final leg (32) the cardboard strips (3) enter from the above into the tube-forming machine (1), whereby said final leg (32) is a descending leg of said path.

An intermediate leg (31) of said path (30, 31, 32) is above a space between the tube-forming machine (1) and the feed unit (2).

A solution equally advantageous according to the present invention implies a different positioning of the intermediate leg (31) which, rather than above the space between the tube-forming machine (1) and the feed unit (2), is at a height less than a predetermined value (for example, at a height less than 30 cm) above the floor. In this case, the final leg (32) is an ascending part of said path. To avoid that the operator is obstructed by said intermediate leg, in this case it can be arranged a step that allows the same operator to pass over the intermediate leg when this is necessary. Or, in this case, said intermediate leg (31) can run in a box-shaped guide provided in the floor.

In each of the two cases described above, that is, both in the case that the intermediate leg (31) of said path is above the space between the tube-forming machine (1) and the feed unit (2), and in the case that said intermediate leg (31) is at a level sufficiently low to allow the operator to move freely between the tube-forming machine (1) and the feed unit (2), the desired result is obtained.

According to the example shown in FIG. 4, the reels (21) feeding the strips of cardboard (3) are positioned with their axes oriented perpendicular to the axis of the spindle (10), so that the production system as a whole is further compacted.

In practice the details of execution may vary in any equivalent way as for what concerns the individual elements described and illustrated, and their mutual arrangement, without departing from the scope of the adopted solution and thus remaining within the limits of the protection granted to the present patent.

1. Equipment for producing cardboard tubes, the equipment comprising:
a tube-forming machine comprising a means for forming cardboard tubes with strips of cardboard helically wound on a forming spindle;
a feeding unit for feeding said cardboard strips; and
a guide means for guiding the cardboard strips along a predetermined path between the feeding unit and the tube-forming machine, wherein in a final section of said predetermined path the strips of cardboard enter into the tube-forming machine, said guide means being arranged and acting, along the predetermined path, such that in said final section of said predetermined path the cardboard strips enter from above or from a bottom into the tube-forming machine, so that said final section is a descending or an ascending section of said predetermined path.

2. Equipment according to claim 1, wherein said tube-forming machine comprises an outer casing and said feeding unit comprises a supporting structure supporting one or more bobbins from which the cardboard strips are drawn, said means for guiding the strips of cardboard comprising a plurality of rollers arranged at a predetermined height from a surface on which the tube-forming machine and the feeding unit rest.

3. Equipment according to claim 1, wherein an intermediated section of said predetermined path is above a space comprised between the tube-forming machine and the feeding unit or said intermediate section is at a height lower than a predetermined value with respect to a surface on which the tube-forming machine and the feeding unit rest.

4. Equipment according to claim 1, wherein the cardboard strips are drawn from corresponding bobbins mounted on respective shafts supported by a fixed structure of the feeding unit, said shafts being parallel or orthogonal to said forming spindle.

5. A method for producing cardboard tubes, the method comprising:
using a tube-forming machine comprising a means for forming cardboard tubes with strips of cardboard helically wound on a forming spindle;
using a feeding unit for feeding said cardboard strips; and
using a guide means for guiding the cardboard strips along a predetermined path between the feeding unit and the tube-forming machine, wherein in a final section of said predetermined path the strips of cardboard enter into the tube-forming machine, wherein in said final section of said predetermined path the cardboard strips enter from above or from a bottom into the tube-forming machine, so that said final section is a descending or an ascending section of said predetermined path.

6. A method according to claim 5, wherein an intermediated section of said predetermined path is above a space comprised between the tube-forming machine and the feeding unit.

7. A method according to claim 5, wherein an intermediated section of said predetermined path is at a height lower than a predetermined value with respect to a surface on which the tube-forming machine and the feeding unit rest.
